(19) United States
(12) Patent Application Publication
(10) Pub. No.: US 2017/0310630 A1
(43) Pub. Date: Oct. 26, 2017

(54) User Context Mechanisms For Online Communication Platforms

(71) Applicant: ALW World LLC, Dubai (AE)

(72) Inventors: Mohamed Soltan, Dubai (AE); Mervin Pillay, Kwazulu Natal (ZA)

(21) Appl. No.: 15/498,026

(22) Filed: Apr. 26, 2017

Related U.S. Application Data
(60) Provisional application No. 62/327,528, filed on Apr. 26, 2016.

(51) Int. Cl. H04L 12/58; G06F 3/0481; G06F 3/0482; H04L 29/08

(52) U.S. Cl. CPC H04L 51/32; H04L 67/306; H04L 67/18; G06F 3/04817; G06F 3/0482; H04L 51/04

(57) ABSTRACT

An online communication platform, such as a social networking site, in which user indicia and user-specified content are presented proximate user context mechanisms. User context mechanisms may include indicia of circumstances local to an associated user, such as local time of day, difference in time from the time at the viewing user's location, and local weather conditions. User context mechanisms may also include social cues, such as user-specified interests, mood, or other passively specified information, which may be rendered on displays of other users to provide enhanced social context for online interactions.

### TECHNICAL FIELD

The present disclosure relates in general to online communications, and in particular to mechanisms for online communication platforms to convey contextual information amongst participants.

### BACKGROUND

Online communication platforms, such as email, real-time chat or messaging applications, and social networks, have become a predominant means by which individuals communicate. While such platforms enable near real-time communications amongst individuals in diverse locations, most such communication mechanisms provide little or no contextual information between participants. Users have very limited information regarding the real-world environment in which other users operate. As a result, communications and relationship-building can be inhibited. This problem becomes particularly significant as between individuals who communicate largely, if not entirely online, with little or no real-world contact, and for individuals in diverse geographic locations.

### SUMMARY

An intuitive online communication platform, such as a social networking platform, is provided. Users can view profile information concerning one another, or other displays incorporating indicia of other users. The displays may include local contextual information associated with a subject user, such as a local time, time difference and/or local weather information at the other user's last-reported location. The contextual information may be displayed proximate user interface elements that are selectable to initiate communications with associated users, thereby providing timely local context to users with whom communications are conducted.

The profile information may also include social cues, through which users may passively provide others with information about a user's needs, interests, personal events/milestones and other information. Contextual information and/or social cues can be used to facilitate online communications and replicate levels of empathy and understanding more commonly associated with offline, or even cohabitating, relationships.

### BRIEF DESCRIPTION OF THE DRAWINGS

FIG. 1 is a schematic block diagram of a computing environment, in accordance with one embodiment.

FIG. 2 is a schematic block diagram of a user computing device.

FIG. 3 is a process diagram for reporting user contextual information to other users.

FIG. 4 is a user electronic device display conveying user contextual cues proximate communication mechanisms.

FIG. 5 is a user electronic device display conveying user-associated local weather information.

FIG. 6 is a user electronic device display conveying user contextual information proximate communication mechanisms.

FIG. 7 is a user electronic device display with user local contextual information and social cues.

FIG. 8 is a user electronic device display with social cues proximate a user-to-user communication mechanism.

FIG. 9 is a user electronic device display aggregating social cues from social network contacts in a scrollable list.

FIG. 10 is another user electronic device display aggregating social cues from social network contacts in a scrollable list.

FIG. 11 is a user electronic device display aggregating social cues from social network contacts, with further aggregation by content sub-type.

FIG. 12 is a social network group display with user social cues and user local time and weather indicia.

FIG. 13 is another social network group display with a group event card having integrated polling mechanisms.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Embodiments of the present invention are generally directed to systems and methods for online communication, providing participants with contextual information to improve communication. Embodiments allow users to remain up-to-date with their contacts, anywhere in the world, providing real-time or near real-time insight into the current state of individuals with which they communicate, potentially including information indicative of a physical environment occupied by users. By integrating streamlined contextual cues into the communication platform user interface, online communications can be improved.

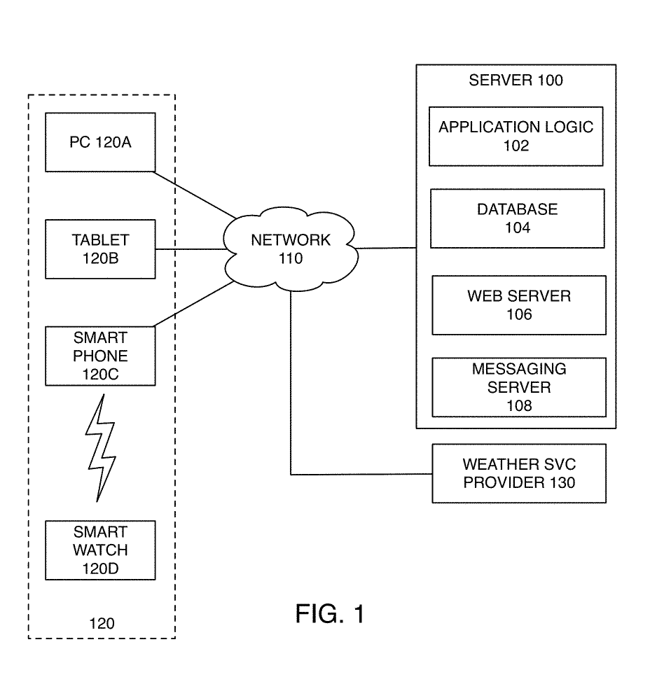

FIG. 1 is a schematic block diagram of a computing environment in which embodiments of the invention can be implemented. Server 100 communicates, inter alia, via computer network 110, which may include the Internet, with user personal electronic devices 120, such as personal computer 120A, tablet computer 120B, smart phone 120C and smart watch 120D. While FIG. 1 illustrates four exemplary user devices, it is contemplated and understood that implementations may include large numbers of user devices. For example, some implementations may include user devices of different types for each of many individuals around the world.

Server 100 implements application logic 102, and operates to store information within, and retrieve information from, database 104. The term “database” is used herein broadly to refer to a store of data, whether structured or not, including without limitation relational databases and document databases. Web server 106 hosts one or more Internet web sites enabling outside user interaction with, amongst other things, application logic 102 and database 104. Messaging server 108 enables instant messaging, such as SMS or MMS communications or app notifications, between server 100 and one or more of user devices 120.

While depicted in the schematic block diagram of FIG. 1 as a block element with specific sub-elements, as known in the art of modern web applications and network services, server 100 may be implemented in a variety of ways, including via distributed hardware and software resources and using any of multiple different software stacks. Server 100 may include a variety of physical, functional and/or logical components such as one or more each of web servers, application servers, database servers, email servers, storage servers, SMS or other instant messaging servers, and the like. That said, implementations of server 100 will typically include at some level one or more physical servers, at least one of the physical servers having one or more microprocessors and digital memory for, inter alia, storing instructions which, when executed by the processor, cause the server to perform methods and operations described herein.

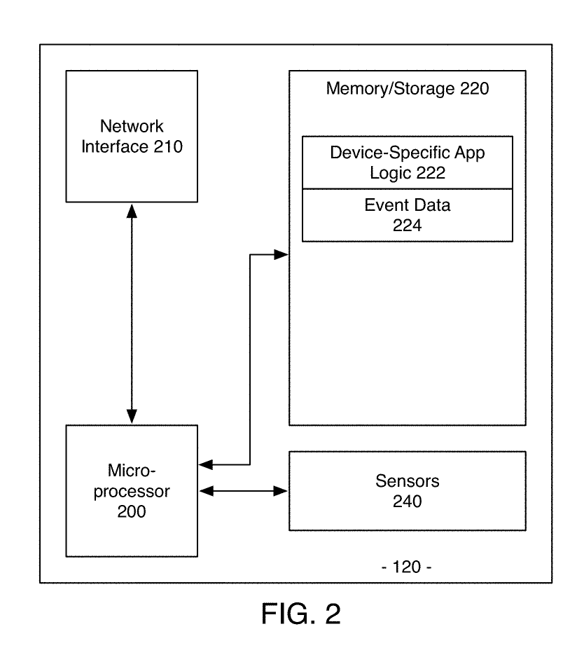

FIG. 2 is a schematic block diagram of an exemplary user device 120. User device 120 includes microprocessor 200, communicating externally via network interface 210 which may include one or more communication channels such as a wired or wireless Ethernet interface, Bluetooth, NFC, USB, or the like. Microprocessor 200 communicates with memory 220 and device sensors 240. Memory 220 may include, e.g., random access memory, SSD, hard disk drive, other types of digital storage, and combinations thereof. Sensors 240 may include device-specific sensors such as, in the case of smart phone 120C, temperature sensors, Global Positioning System (GPS) sensors, orientation sensors/accelerometers, ambient light sensors, audio transducers and the like.

In an embodiment, user devices 120 each include device-specific application logic 222 stored within memory 220 and executed by microprocessor 200. The device specific application logic 222 may be, for example: an application downloaded to and installed on a smart phone or tablet computer from an app store; a software application installed on a laptop or desktop computer; or content running within a local web browser application. Memory 220 further includes event data 224, providing a local data store for information concerning device utilization.

Contextual Information, Such as Local Time and Weather

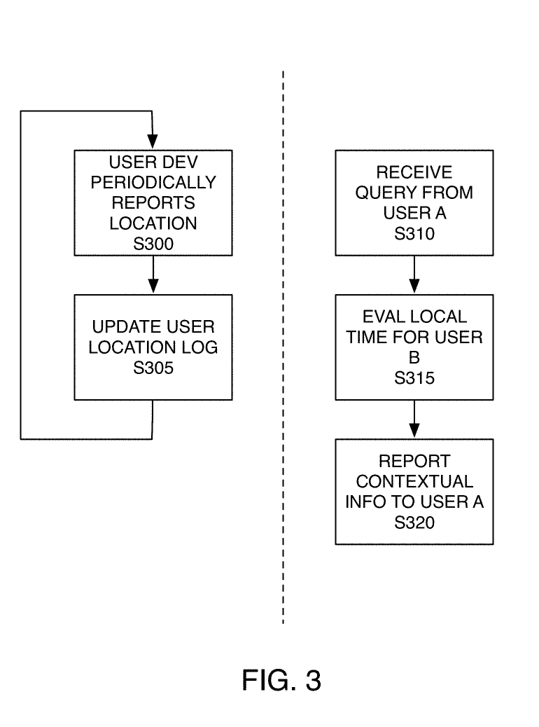

In operation, the communication platform implemented by embodiments described herein provides contextual information concerning other individuals with whom a user communicates, with the information presentation cued to interactions to provide enriched context to inter-user communications and content consumption. For example, in some embodiments, time zone information and time difference can be provided directly in connection with the presentation of a content or communications associated with another user. FIG. 3 illustrates an exemplary process for reporting of time zone contextual information. In step S300, user devices 120 periodically report their location to server 100 during the course of communications via network 110. In some circumstances, location reporting may be explicit. For example, server 100 may query device 120 for its location, with an explicit location being returned to server 100. Explicit locations can be determined in a number of different ways, such as via querying an onboard GPS or geolocation module implemented within the user device, or by querying the user for manual entry via a user interface rendered by the user device. In other circumstances, device location may be determined implicitly or by derivation, such as via IP address localization. In some embodiments, server 100 may utilize both implicit (derived) and explicit geolocation techniques in order to track a user device's location. Location information received by server 100 is logged within database 104, thereby maintaining a record of each user's last-known location (step S305).

Server 100 store received location information directly, or it may store derivatives thereof that remain indicative of the associated user's location with a desired level of precision. For example, in some embodiments, very precise location information may be received by server 100 but considered private, and undesirable for persistent storage within database 104. In such circumstances, it may be desirable to generalize the location information reported in step S300 prior to storage in step S305. For example, geographic location information reported in step S300 may be utilized to cross-reference the user's current time zone, with only time zone identification being stored in step S305, thereby enabling server 100 to provide location information at a contextually-relevant level, without compromising user privacy associated with explicit location information.

While server 100 maintains a log of user location information (or at least maintains most recent location information), users may utilize a communications platform (such as social networking and/or messaging), implemented via server 100, to communicate with other individuals. Location information stored in step S305 can be utilized to provide one or more types of contextual information regarding other users on the platform. For example, in some embodiments, it may be desirable to convey the local time (whether in absolute local time terms, or a number of hours difference in time zone or both) of other individuals with whom a user seeks to communicate. In step S310, server 100 receives a query from a user (user A) that relates to another user (user B). Queries may include, without limitation, initiation of a chat communication, viewing of a profile page, viewing a content item authored by the other user, or drafting of a message intended for the other user. In step S315, server 100 determines a local time for user B, and/or calculates a time differential between user A and user B by evaluating time zones associated with each user's last known location, stored in step S305. In step S320, server 100 responds to the query of step S310 with associated contextual information, e.g. information indicative of the local time for user B.

The information indicative of the local time for user B may then be displayed on the user device of user A via components of a user interface, preferably presenting information concerning user B's time via a user interface mechanism directly proximate the content associated with user B and/or the communication mechanism (e.g. chat window) with which User A intends to communicate with User B. For example, the local time at user B's last known location may be displayed proximate a name, photo or other indicia of user B rendered on the display of user A's user device (displaying either the current local time for user B and/or the local time for User B at the time content was contributed by user B). In other embodiments, the number of hours difference in local time between user A and user B may be displayed. In either case, user A received contextual information describing the local time at user B's location. Preferably, to the extent that user B engages in communications with user A, user B will also see contextual information including the local time at user A's location. Thus, prior to and/or during the course of communications between user A and user B, each user will understand the local time at the others' location. Understanding of local time can provide insight as to, e.g., whether another user is likely to be awake and available for communications, whether another user is likely to be working or at leisure, whether another user is likely to be tired or freshly awoken, etc.

Another form of contextual information that may be provided is local weather. Local weather can include current temperature, local forecast, and/or conditions such as rain, clouds, sun or snow. In some embodiments, a user's local weather can be determined by server 100 by querying an API implemented by third party weather service provider 130 with user location data stored in step S305. Weather information associated with another user's location can then be reported, along with local time information, in step S320. Presenting weather contextual information associated with other users directly within an online communications environment can further assist users in understanding the current circumstances of others with whom they are communicating, potentially making communications more personal, relevant and engaging.

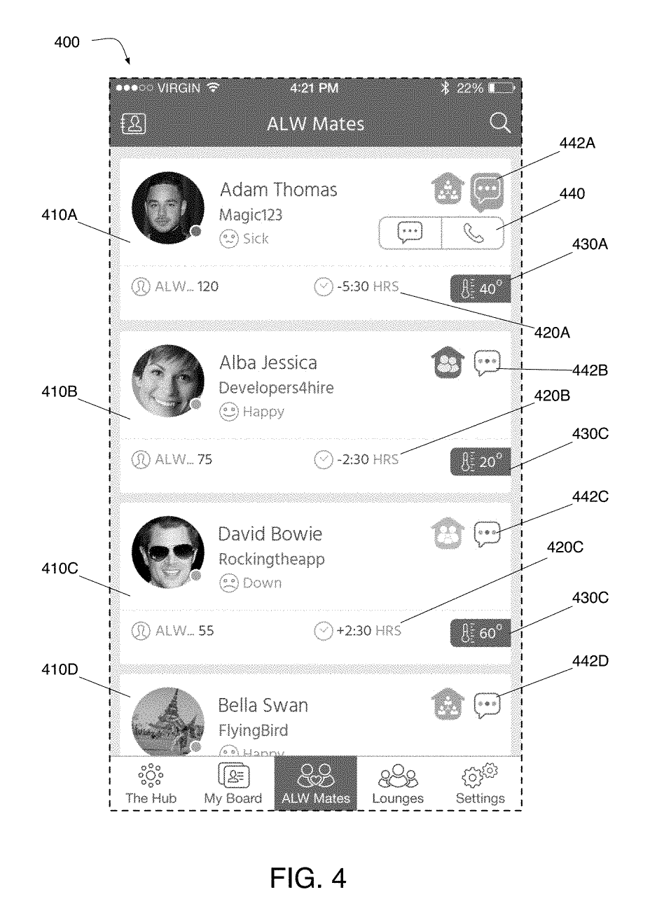

FIG. 4 is a mobile application user interface, in accordance with one embodiment. Display 400 is presented on a display screen of user device 120C, via interaction of user device 120C with server 100. Display 400 provides a scrolling list of social networking contacts (referred to in the user interface of FIG. 4 as “ALW Mates”), with a contact overview card 410 for each contact. Contact overview cards 410A-D each include, inter alia, a local time difference indicium 420, conveying the difference in time between a user's local time and the local time of the contact associated with the contact overview card. Time difference indicia 420 are thereby presented directly proximate mechanisms for initiating communications with the associated user, such as telephone calling indicium 440, or chat indicia 442. Thus, for example, in the embodiment of FIG. 4 in which user device includes currently time indicator 444 indicating that the user's local time is 4:21 pm, the user may determine directly at a glance that the user associated with card 410A is currently mid-morning, such that they may be at work. Meanwhile, the user associated with card 410C has a local time of nearly 7 pm, such that the user may be done with working and considering dinner. The user may use this information to enrich, and improve the social relevance of, communications directed to each of the users associated with contact cards 410A-410D.

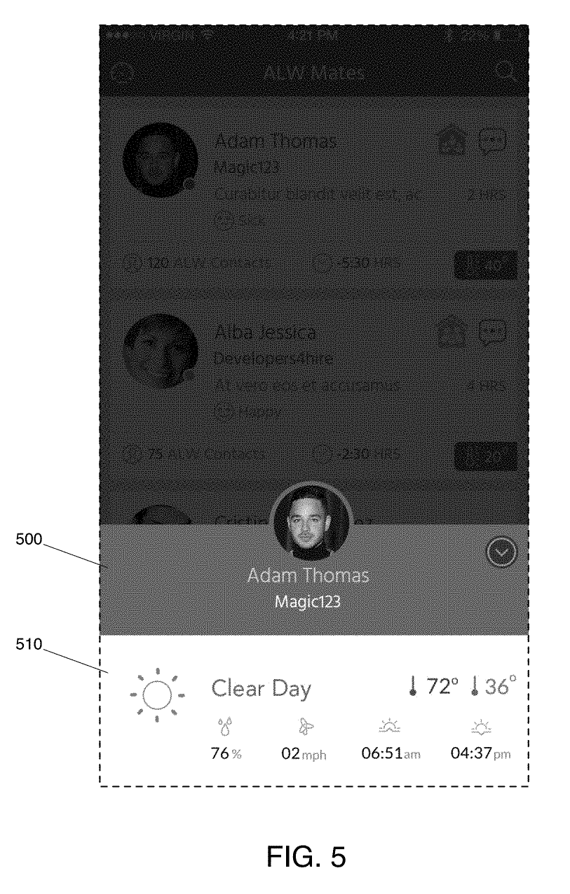

Contact cards 410 further each include a local temperature indicia 430, conveying information concerning the local weather at the location of the contact associated with the contact overview card. The local weather indicia of FIG. 4 provide local temperature conditions, and can be selected (e.g. via tapping, using a touch screen user interface) to display a detail view of local weather conditions. For example, selection of local temperature indicium 430A on contact card 410A may yield the display of FIG. 5, forming a dismissible overlay above the contacts card list display of FIG. 4. The local weather detail display embodiment of FIG. 5 presents an indicator 500 of the individual for whom local weather is being displayed, and a detailed whether display pane 510 showing overall weather description, chance of precipitation, wind speed, time of sunrise, time of sunset, daily high temperature and daily low temperature. Thus, as with time difference indicia 420, display of local weather indicia 430 directly proximate mechanisms for communication with the users whose local weather conditions are displayed, may help enrich and contextualize user-to-user communications and content consumption.

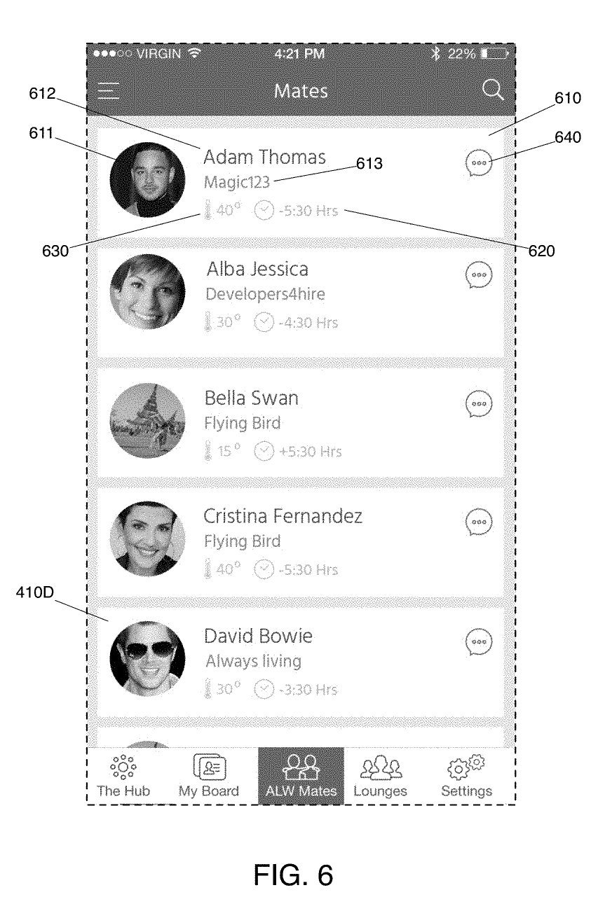

FIG. 6 illustrates a user device display screen with an alternative embodiment of a contact card list, having local weather and local time difference indicia for each contact. The embodiment of FIG. 6 presents a compact communication contact list with local time and weather condition. For example, contact card 610 includes user profile picture 611, user name 612, user handle 613, time difference indicium 620, local weather indicium 630, and chat icon 640. Chat icon 640 may be selected (e.g. via tapping in a touch screen user interface, or clicking in a mouse-driven user interface) to initiate chat communications with user 612. Thus, local time and weather information for the user associated with card 610 are reflected directly proximate a mechanism to initiate communications (in this case, on a common user contact card with chat icon 640).

Social Cues

Many users maintain a broad variety of relationships within their online social networks. However, online communications are often topically-directed and/or purpose-driven. Therefore, individuals often interact regarding only very limited subject matter, even when relationships amongst them are strong. Furthermore, because individuals often maintain large numbers of online relationships and must handle high volume electronic communications, some individuals may be hesitant to impose on others by, e.g., asking for help or raising new topics of interest. Even when individuals would like to leverage their online relationships for such purposes, they may not know who of the many individuals within their networks would be appropriate for inquiry.

Therefore, it may be desirable for an online communications platform to provide additional social context mechanisms whereby users can passively provide social cues to others, such as conveying insight into topics or issues currently of interest to them. In accordance with some embodiments, this objective can be achieved by populating pre-defined and/or user-defined topical information fields that can be presented to other individuals with whom they communicate in appropriate circumstances, in order to passively provide others with insight into current topics of interest. References to passive presentation of social cues may include content presentations that are not directly targeted to other users or groups of users, but rather made available for discovery by other users.

One such passive topical field may be Help. Help enables a user to broadcast a topic or task with which the user could currently use assistance. Other individuals communicating with the user can then view the Help content associated with the user and, if the content relates to a matter with which the individual can and desires to assist, open communications regarding that topic. Meanwhile, if a viewing individual cannot or does not desire to engage with the user concerning the Help topic, neither the requesting or viewing individual experiences social repercussions of a declined request for assistance.

Another passive topical field is Mood. The Mood field enables users to provide an indicium of their current emotional state, such as happy, sad, stressed, sick, uncertain, worried, calm, tired or the like. Preferably, the Mood field indicia are selected from amongst an array of emojis or other icons.

Another passive topical field is a user-defined field, referred to in some embodiments as My Zone. The user-defined My Zone field provides users with a blank canvas with which they can passively inform others with whom they communicate about any information desired.

Another passive topical field can be referred to in some embodiments as NBT (Next Big Thing). NBT can be used to highlight events for which a user is pursuing, such as a meeting, exam, party, dinner, vacation, or the like.

Another passive topical field can be referred to in some embodiments as Hooked On. Hooked On can be used to passively communicate user current interest subjects to the user's social network, such as sports, books, TV shows and the like. The platform further allows users to define their interest details. In some embodiments, information to be populated in Important Dates can be gathered during user onboarding and/or configured in a user's profile.

Another passive topical field may be Tips. Tips can be used similarly to a Help field, but enabling users to passively share useful tips to the user's social network. Yet other passive topical fields can enable a user to populate trivia, humor, jokes, quotes, and/or links to information of interest.

In some embodiments, users can select one or more social cues, such as those described above, for display on a profile page. A card-based user interface can be provided, in which each social cue is displayed on a different card within a user's profile UI. In some embodiments, one or more social cues will be mandatorily populated on the user's profile page, with additional social cues being selectable by the user, as desired.

In some embodiments, display of social cues and/or contextual information to other users may be dependent on a user classification. A user may assign other users into one or more of multiple user classifications or groups, such as FAMILY, FRIENDS, BUDDIES and OTHERS. Visibility of social cue information may be restricted to one or more of the user classifications. For example, a user may make a HUMOR card social cue available only to users within the FRIENDS classification who view the user's profile page, while making a NEXT BIG THING card social cue also available to OTHERS who views the user's profile page.

In some embodiments, systemic constraints can be imposed on utilization of passive communication mechanisms such as those described above. Such constraints may improve content quality, and the effectiveness with which social cues are conveyed, by causing users to prioritize content. For example, in some embodiments, it may be desirable to provide six options for passive content cards, but only allow the user to display four of those six cards on their profile at a given time.

In some embodiments, users may be allowed to reconfigure the displayed titles of passive content cards. Thus, titles of cards having a common type of content can be configured for different users to reflect preferred terminology, language, and/or dialect. The tools for passive presentation of content and contextual information may then become adaptable to a diverse range of social settings, and largely independent of a particular language or geographic location. User-configuration of social cue content card titles may be particularly advantageous in a communication platform used internationally, and therefore effectively combined with local time and local weather indicator mechanisms described hereinabove.

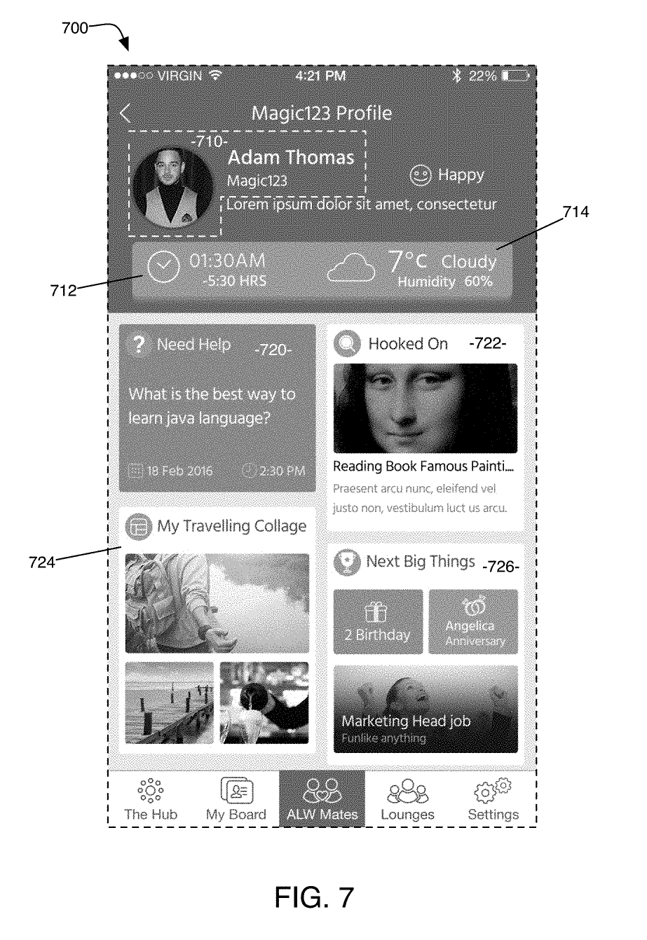

FIG. 7 is an exemplary embodiment of a user profile page, rendered on a mobile application display running on user device 120C in response to, e.g., selection of a contact overview card from the list of contact cards in FIG. 4. User profile display 700 includes user identification indicia 710, contextual information such as local time and time difference indicia 712, and local weather indicium 714. Display 700 further includes multiple user-configurable social cues, including: Help card 720, Hooked On card 722, Photo album 724 and Next Big Things card 726.

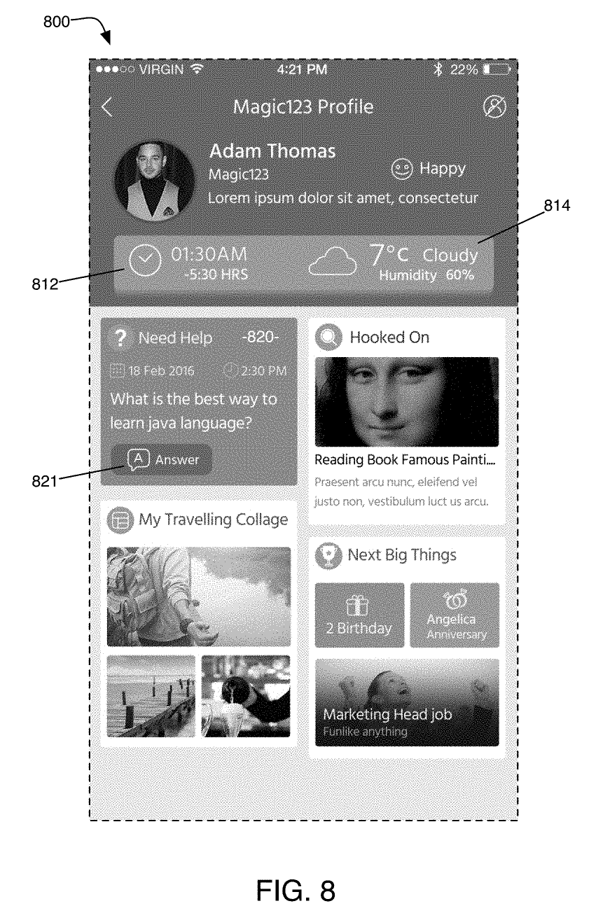

FIG. 8 is another embodiment of a user profile page 800, having local time and time difference indicia 812 and local weather indicium 814. An alternative Help card social cue 820 includes Answer icon 821. Answer icon 821 can be selected for initiating a response to the question reflected on Help social cue 820. Thus, Answer icon 821 is a communication mechanism directly associated with social cue 820, and with further social context provided by local context indicia 812 and 814.

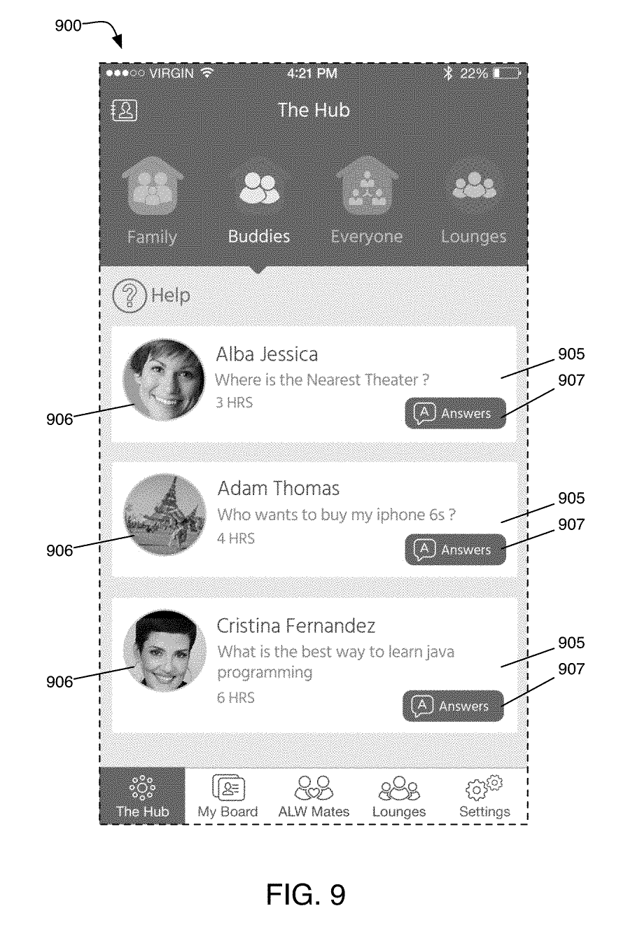

In addition to, or instead of, presenting social cues on displays associated with a particular user, social cues can also be aggregated across multiple individuals within a user's social network. For example, FIG. 9 is a mobile application display 900 aggregating social cue requests for Help from multiple individuals within the user's social network. Each card 905 conveys a summary of current content for a Help social cue associated with user 906, preferably arranged in a scrollable list. A card 905 can be selected to, e.g., view more detail about the request, view responses and/or contribute a response. A communication mechanism to provide a response can also be initiated directly via selection of icon 907.

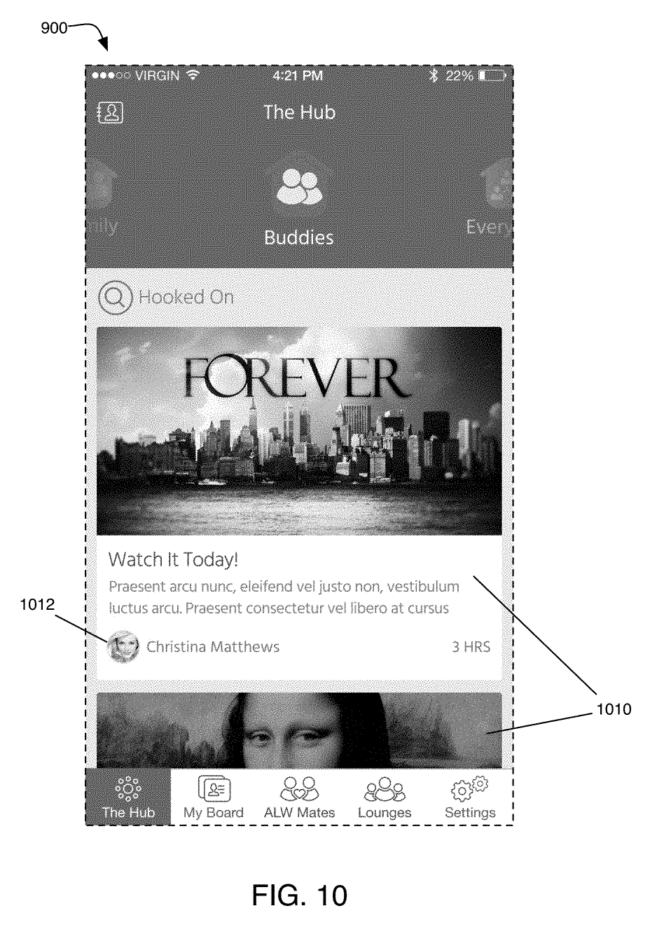

Similarly, FIG. 10 illustrates a mobile application display 1000 aggregating content from Hooked On social cues currently configured by other individuals within a user's social network. Content is presented in a scrollable list of cards 1010, with user designator 1012 indicating the user with whom a social cue card on each card 1010 is associated.

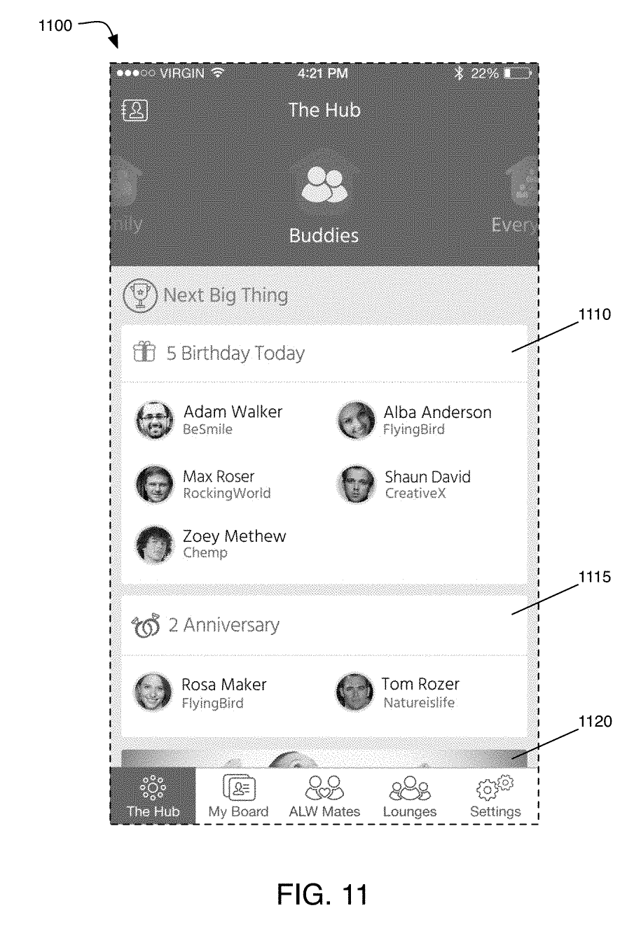

FIG. 11 is a mobile application display 1100 aggregating content from Next Big Thing social cues currently configured by other individuals within a viewing user's social network. In the display of FIG. 11, social cues are aggregated broadly within the social cue type (i.e. Next Big Thing), and the further aggregated by content sub-type. For example, Next Big Thing social cue card 1110 aggregates birthday events associated with different individuals onto a single card. Next Big Thing social cue card 1115 aggregates anniversary events associated with different individuals onto a single card. Meanwhile, other content items for which sub-type aggregation is not possible or desired, may be presented separately on cards integrated into a common scrollable list (e.g. card 1120). By aggregating content items sharing a common content type onto a single card within a social networking feed, viewing users may better understand each content item in the context of the user's overall social circles, while simultaneously increasing the content density of the user's feed.

In accordance with another aspect, user groups can be formed. Content and events associated with the group can be shared on a group display, sometimes referred to as a Lounge. While social network groups may be a particularly rich environment for user interaction, many social network groups are used to aggregate users with a common interest, who may have little or no contact with one another outside the group. Therefore, communications within traditional social network groups are often particularly lacking in real-world social context, thereby inhibiting the effectiveness of user-to-user communications. Therefore, mechanisms described herein, such as local time and weather indicia and/or user-specified social cues, may be particularly advantageous within a social network group environment.

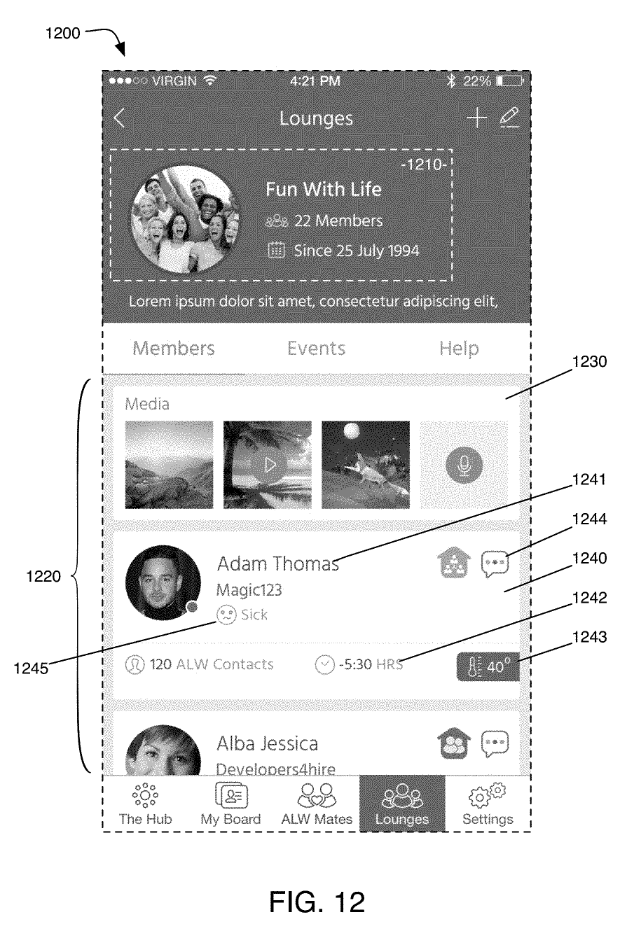

FIG. 12 illustrates a mobile application Group Member display 1200 associated with a social network user group. Display indicia 1210 provides information identifying the group with which display 1200 is associated. Region 1220 provides a scrollable list of content cards associated with the group, including group shared content card 1230. Region 1220 also includes group member contact overview cards 1240, analogous to the contact overview cards described elsewhere hereinabove, including: user indicator 1241, local time indicator 1242, local weather indicator 1243, chat initiation icon 1244 and mood social cue 1245. Providing such cues directly within a social network group display may provide users having little real-world contact with additional social context to facilitate and enrich communications amongst them.

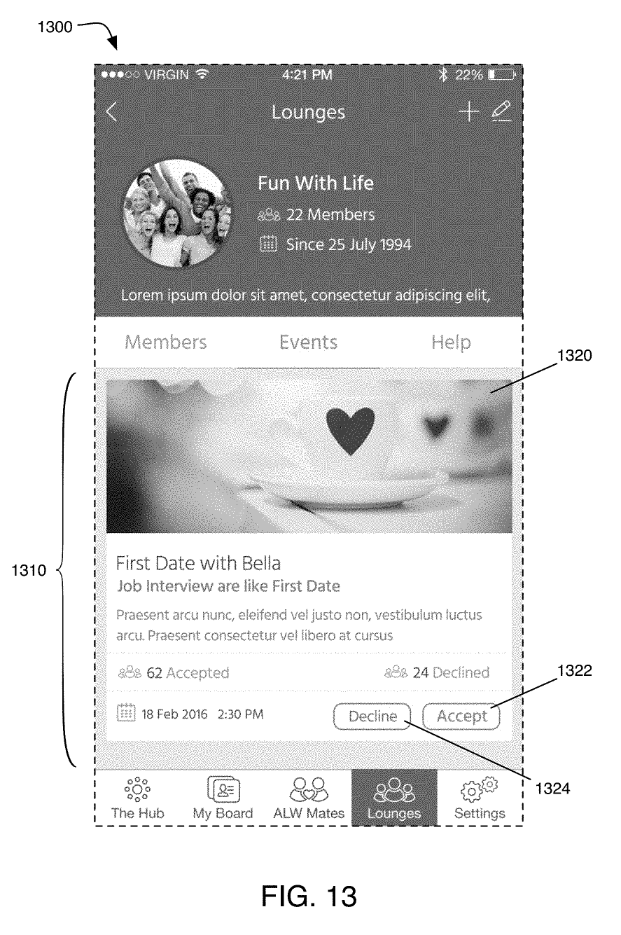

FIG. 13 illustrates a mobile application Group Event display 1300. Region 1310 includes a scrollable list of content cards 1320, each associated with a group event. Cards 1320 can be selected for further details and information concerning the event, while attendance polling mechanisms 1322 and 1324 can be accessed to directly indicate whether a user intends to attend the associated event.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or any appended claims.

1. A computer-implemented method for communication amongst a plurality of users via an Internet-connected social network server, the method comprising:
receiving, from one or more network-connected electronic devices associated with each of the plurality of users, information indicative of each user's location;
storing, by the social network server, said information indicative of each user's last known location or a derivative thereof;
transmitting information for rendering a display on a network-connected electronic device associated with a first of said users, the displayed information comprising: for one or more other users, an indicium of user identity and an indicium of a local time at a last known location of the user associated with the indicium of user identity.

2. The method of claim 1, in which the step of transmitting information for rendering a display comprises: transmitting a user profile page associated with a second one of said users, the user profile page comprising an indicium of the second user's identity, an indicium of a local time at a last known location associated with the second user, and one or more content items authored by the second user.

3. The method of claim 2, in which the one or more content items comprise one or more passive social cues.

4. The method of claim 2, in which the user profile page further comprises an indicium of one or more weather conditions associated with the second user's last known location.

5. The method of claim 1, in which the displayed information further comprises, for one or more of the other users: a communication icon rendered proximate the indicium of local time, selectable by the viewing user to initiate communication with the user associated with the indicium of local time.

6. The method of claim 5, in which the communication icon comprises a chat icon; the method further comprising:
selecting one or said communication icons by a viewing user; and
initiating communication between the viewing user and an other user associated with the selected communication icon.

7. The method of claim 1, in which:
the step of transmitting information for rendering a display further comprises the substep of querying a weather server for local weather conditions associated with the last known location of each of the one or more other users;
and in which the displayed information comprises, for each of the one or more other users, an indicium of the local weather conditions associated with the user's last known location.

8. The method of claim 3, in which the one or more passive social cues comprise a request for help previously configured by the second user.

9. The method of claim 8, in which the request for help social cue further comprises a communication icon selectable by the viewing user to initiate communication with the second user.

10. The method of claim 1, in which the displayed information further comprises, for each of the other users, a social cue previously specified by the user.

11. The method of claim 10, in which the social cue comprises a user interface element indicative of a topic of current interest to the user.

12. The method of claim 1, in which the displayed information further comprises a user interface element that can be selected to initiate a voice call or text message with another user.

13. A method for communication amongst a plurality of users of an online communication platform, the method comprising:
receiving and storing, for each of the plurality of users, social cue information transmitted from a network-connected personal electronic device;
transmitting, to a network-connected electronic device associated with a first of said users, information for rendering a display comprising: a feed comprising elements of the social cue information displayed proximate indicium of a user from whom the social cue information was received.

14. The method of claim 13, in which the feed comprises elements of social cue information displayed proximate indicium of a user from whom the social cue information was received, for a single predetermined social cue.

15. The method of claim 14, in which the elements of social cue information are further aggregated by information sub-type for rendering in the display.

16. A computer-implemented method for rendering a first user's social network profile on personal electronic devices associated with each of a plurality of users, the method comprising:
transmitting, to a personal electronic device associated with the first user, information for rendering a user profile display having a plurality of content sections with predetermined titles rendered proximate thereto, the user profile display including a user interface element selectable to initiate modification of one or more of said content section titles;
receiving, from the first user's personal electronic device, a communication indicative of actuation of the user interface element;
querying the first user's personal electronic device for one or more new content section titles; and
subsequently transmitting information to personal electronic devices associated with each of a plurality of users, for rendering a modified display of the first user's profile, the first user's modified profile display comprising the plurality of content sections and the one or more new content section titles rendered proximate thereto.

17. The method of claim 16, in which the first user's modified profile display further comprises an indicium of a local time at a last known location associated with the first user.

18. The method of claim 16, in which the first user's modified profile display further comprises an indicium of local weather conditions at a last known location associated with the first user.

19. The method of claim 16, in which the one or more content sections comprise one or more social cues.
